(19) United States
(12) Patent Application Publication
(10) Pub. No.: US 2014/0358616 A1
(43) Pub. Date: Dec. 4, 2014

(54) ASSET MANAGEMENT FOR A COMPUTER-BASED SYSTEM USING AGGREGATED WEIGHTS OF CHANGED ASSETS

(71) Applicant: International Business Machines Corporation, Armonk, NY (US)

(72) Inventors: Philip T. Berkland, Austin, TX (US); Leugim A. Bustelo, Austin, TX (US); Bradley Childs, Austin, TX (US); Robert S. Goodman, Austin, TX (US); Justin Tyberg, Mahopac, NY (US)

(73) Assignee: International Business Machines Corporation, Armonk, NY (US)

(21) Appl. No.: 13/908,412

(22) Filed: Jun. 3, 2013

(51) Int. Cl. G06Q 10/06

(52) U.S. Cl. CPC G06Q 10/06312
USPC 705/7.22

(57) ABSTRACT

Asset management for a computer-based system includes detecting, using a processor, a change to at least one of a plurality of assets of the computer-based system, wherein the plurality of assets are managed using version control, and determining a weight for each changed asset. Using the processor, an aggregate weight is calculated according to the weight of each changed asset and the aggregate weight is compared with a threshold weight. Responsive to determining that the aggregate weight exceeds the threshold weight, a state of the plurality of assets of the computer-based system is recorded.

### BACKGROUND

Modern computer-based systems are capable of making decisions and/or answering questions. In formulating a response, such computer-based systems utilize a large number of “assets.” Examples of the assets used include, but are not limited to, configuration parameters and/or files, program code, data sources such as Web pages, dictionaries, other texts, machine learning models, and the like. In general, the computer based system consults the various assets to generate a response.

Typically, the computer-based system is tuned to increase performance and accuracy using a feedback loop. The feedback loop generally involves changing one or more assets, testing the computer-based system using the changed assets periodically, and determining whether to adopt or abandon the change(s). Changes to the assets are either adopted or abandoned based upon observed variation in accuracy and/or performance of the computer-based system.

### BRIEF SUMMARY

A method includes detecting, using a processor, a change to at least one of a plurality of assets of a computer-based system, wherein the plurality of assets are managed using version control, and determining a weight for each changed asset. The method also includes calculating, using the processor, an aggregate weight according to the weight of each changed asset and comparing, using the processor, the aggregate weight with a threshold weight. The method further includes recording a state of the plurality of assets of the computer-based system responsive to determining that the aggregate weight exceeds the threshold weight.

A system includes a processor programmed to initiate executable operations. The executable operations include detecting a change to at least one of a plurality of assets of a computer-based system, wherein the plurality of assets are managed using version control, determining a weight for each changed asset, and calculating an aggregate weight according to the weight of each changed asset. The executable operations also include comparing the aggregate weight with a threshold weight and, responsive to determining that the aggregate weight exceeds the threshold weight, recording a state of the plurality of assets of the computer-based system.

A computer program product includes a computer readable storage medium having program code stored thereon. The program code is executable by a processor to perform a method. The method includes detecting, using the processor, a change to at least one of a plurality of assets of a computer-based system, wherein the plurality of assets are managed using version control, and determining, using the processor, a weight for each changed asset. The method also includes calculating, using the processor, an aggregate weight according to the weight of each changed asset and comparing, using the processor, the aggregate weight with a threshold weight. The method further includes recording a state of the plurality of assets of the computer-based system using the processor responsive to determining that the aggregate weight exceeds the threshold weight.

### BRIEF DESCRIPTION OF THE SEVERAL VIEWS OF THE DRAWINGS

FIG. 1 is a block diagram illustrating an example of a computer-based system.

FIG. 2 is a block diagram illustrating an exemplary architecture for a data processing system.

FIG. 3 is a block diagram illustrating an exemplary technique for weighting assets.

FIG. 4 is a flow chart illustrating an exemplary method of managing assets for a computer-based system.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

This specification relates to asset management for a computer-based system that uses aggregated weights of changed assets. In accordance with the inventive arrangements disclosed herein, the assets utilized by a computer-based system are placed under management. In one aspect, the assets are managed using version control operations. Each of the various assets utilized by the computer-based system is assigned a weight. In general, the weight is an indication of the importance of the asset to the computer-based system.

Changes made to one or more of the assets are detected. An aggregated weight is calculated based upon the weight of each of the changed assets. The aggregated weight can be compared to a threshold weight. When the aggregated weight exceeds the threshold weight, one or more programmatic actions, e.g., a workflow, can be performed. These and other aspects will be described in greater detail in the specification below with reference to the drawings.

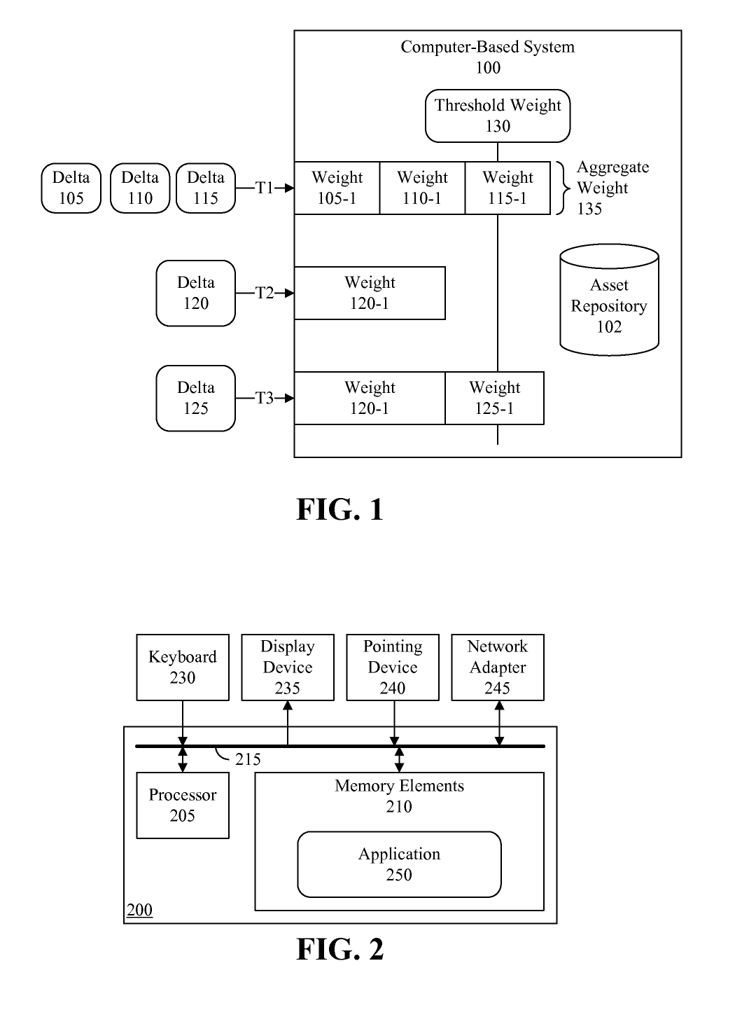

FIG. 1 is a block diagram illustrating an example of a computer-based system (system) 100. System 100 is implemented as a data processing system. It should be appreciated that while system 100 is illustrated using a single data processing system, system 100 can be implemented as a plurality of interconnected, or networked, data processing systems. As such, the embodiments disclosed within this specification are not intended to be limited by the particular number of data processing systems used to implement system 100.

In one aspect, system 100 implements a learning system. A “learning system” refers to a computer-based system that is configured to determine an answer to a question or query. In determining an answer, the leaning system relies upon an extensive set or library of assets. In one aspect, the assets are considered unstructured data. In that case, the learning system may be equipped with functions such as natural language understanding in order to process and/or understand items of unstructured data. In another aspect, the assets may include structured data or an item of structured data.

The phrase “structured data” refers to data that is identifiable because the entire data set of assets has an organized structure. An example of structured data is a database where specific items of information are stored according to a defined methodology in columns and/or rows.

The phrase “unstructured data,” by comparison, refers to data that has no identifiable structure or organization. Examples of unstructured data include images, videos, electronic mail, documents, and text. The phrase “unstructured data” further is used to describe a data set in which individual assets of the data set have an internal structure, but each of the plurality of assets forming the data set does not have the same structure. Some individual assets, for example, contain an internal structure or formatting based upon the software program used to create the asset. In illustration, an electronic mail may have an internal data structure, but a data set including a document, a photo, and the electronic mail is considered unstructured because each asset of the data set does not have a same structure or format.

An “asset” is an item of information or a collection of items of information in digital form. Examples of assets include, but are not limited to, configuration parameters, configuration files, portions of files, program code, data sources such as Web pages or Web sites, documents such as spread sheets, word processing documents, markup language documents, etc., directories, hierarchies or taxonomies, text, dictionaries, machine learning models, video, photos, electronic mail, other collections of information, etc.

In general, the learning system determines several candidate responses to a posed question using the assets that are part of, or accessible to, the learning system. Each candidate response is rated with a confidence score indicating the likelihood that the candidate response is the correct, or most correct, answer to the question. The candidate response with the highest confidence score is selected as the answer to the question.

A learning system typically undergoes tuning using a feedback-driven process or loop to increase performance and accuracy. The feedback loop generally involves changing one or more assets, testing the learning system using the changed assets, and determining whether to adopt or abandon the change(s). The changes to the assets are either adopted or abandoned based upon observed variation in accuracy and/or performance of the learning system.

Due to the significant number of assets required for operation of a learning system, e.g., system 100, a version control system can be either used with the system or incorporated into the learning system. For purposes of explanation, system 100 is described as including a version control system. The version control system can be considered a subsystem, or part, of system 100. In another aspect, inclusion of a version control system within system 100 means that system 100 includes version control functions or is configured to perform the version control operations as described within this specification.

A “version control system” refers to a system that manages assets and changes to assets. The version control system automates the management, e.g., the creation and tracking, of versions of assets managed therein. Within a version control system, an asset is typically referenced using an identifier that includes a version or revision code. Different versions of a particular asset have different version codes thereby facilitating distinction between different version of a same asset, comparison of different versions of the same asset, restoration of a particular version of an asset, and, in some cases, merger of two different versions of an asset. A version control system further may refer to a multi-user system in which two or more users may change the same group or pool of assets.

Accordingly, as pictured in FIG. 1, system 100 includes an asset repository 102. Asset repository 102 can be implemented as a data storage device or other type of computer readable storage medium. Asset repository 102 stores each of the various assets managed and used by system 100. In one aspect, asset repository 102 stores a weight in association with each asset. The weight of an asset is an indication of the importance of that asset to system 100.

In operation, users accessing system 100 can request that a new version of an asset be created, can check out various versions of assets, including newly created versions of assets, make changes to the checked out assets, and check the changed assets back into system 100. In the example pictured in FIG. 1, a variety of different assets have been checked out and modified. For purposes of illustration and ease of description, each changed asset is labelled as a delta. For example, when a user checks an asset out of system 100, the user can edit or otherwise change the asset. The changed asset, referred to as a delta, then can be checked back into system 100.

Deltas 105, 110, and 115 are checked back into system 100 at time T1. Delta 120 is checked back into system 100 and time T2. Delta 125 is checked back into system 100 at time T3. Time T2 occurs after time T1. Time T3 occurs after time T2. As noted, system 100 is a multiuser system. Accordingly, while a single user may submit each of deltas 105-125 at the times indicated, in another aspect, one or more different users may submit different ones of deltas 105-125 at the times indicated. For example, a first user can submit deltas 105-115, a second and different user can submit delta 120, and a third and different user can submit delta 125.

As discussed, each asset is associated with a corresponding weight. Referring again to FIG. 1, delta 105 has a weight 105-1. Delta 110 has a weight 110-1. Delta 115 has a weight 115-1. Delta 120 has a weight 120-1. Delta 125 has a weight 125-1. As each delta is checked into system 100, system 100 can determine the weight for the delta.

In one aspect, system 100 stores a threshold weight 130. As changed assets are checked into system 100, system 100 commits, or stores, each asset that is checked in. Further, system 100 determines the weight of each changed asset that is checked in and aggregates the weight of each changed asset. For example, weights of changed assets can be summed to determine an aggregate weight. At time T1, the weight of each of deltas 105-115 is determined from asset repository 102 and aggregated resulting in aggregate weight 135. System 100 compares threshold weight 130 with aggregate weight 135. Responsive to determining that aggregate weight 135 exceeds threshold weight 130, system 100 can implement one or more programmatic actions.

In the example pictured in FIG. 1, aggregate weight 135, as calculated from deltas 105-115, exceeds threshold weight 130. As such, system 100 implements one or more programmatic actions to be described herein in further detail. System 100 can reset the value of aggregate weight 135 to a baseline or starting value. As shown, system 100 begins calculating aggregate weight 135 anew when delta 120 is checked into system 100 at time T2. Responsive to checking delta 120 into system 100 at time T2, delta 120 is committed. Further, system 100 sets aggregate weight 135 equal to weight 120-1. System 100 takes no further programmatic action responsive to checking in delta 120 since aggregate weight 135 does not exceed threshold weight 130. Later, at time T3, however, delta 125 is checked into system 100 and committed. System 100 determines that delta 125 has weight 125-1. Accordingly, at time T3 system 100 recalculates aggregate weight 135 as a function, or combination, e.g., a sum, of weight 120-1 and weight 125-1. Because aggregate weight 135 again exceeds threshold weight 130, system 100 initiates one or more programmatic actions. As before, aggregate weight 135 further is reset to the baseline value.

In another aspect, system 100 may be configured to track different parts of a file individually. In that case, each portion of the file that is assigned a separate and distinct weight can be considered a separate and distinct asset despite being part of a same file. For instance, system 100 can determine that a particular portion of a single file has been changed, but that another portion has not. Each portion may be considered an asset and assigned a different weight. For example, different modules of a source code file or other program code file can be assigned different weights. In that case, system 100 can determine each portion of the file that has changed and select the weight for the changed portion of the file. System 100 can determined changed portions of a file by performing a comparison of the asset with a prior version of the asset or using another technique.

In one aspect, the programmatic action that is taken by system 100 responsive to aggregate weight 135 exceeding threshold weight 130 is to tag the state of assets in asset repository 102. Tagging the state of assets, in effect, records the state of each asset of system 100 at the time of tagging. Recording the state of assets or assigning a tag, as described, also may be referred to as taking a “snapshot.” The snapshot indicates the particular state, or version, of each asset of system 100 at the time of tagging. Accordingly, the tag serves as a point of reference in a timeline representing the history of asset changes for system 100.

For example, responsive to aggregate weight 135 exceeding threshold weight 130, system 100 tags the current state of assets in asset repository 102. One or more additional programmatic operations that can be formed can include, but are not limited to, sending a message such as an electronic mail, an instant message, or the like, to one or more users or responsible personnel indicating that a tag has been applied. Application of the tag, or a notification of application of a tag, can serve as an indication that testing should be performed upon system 100.

A determination that aggregate weight 135 exceeds threshold weight 130 is an indication that the magnitude of changes to system 100, in the form of changed assets, is considered sufficiently large to merit testing. By setting threshold weight 130 sufficiently low, developers are able to validate changes to assets by initiating testing responsive to a predetermined amount of change to system 100. Further, adjustment of threshold weight 130 allows users to control how many changes or the extent of changes that are accepted into system 100 before triggering testing. If the testing results in a drop in performance or accuracy, for example, the state of assets within system 100 can be rolled back or restored to a particular time in the past as marked by a prior tag.

While tagging and notifications are provided as examples of the programmatic operations that can be performed, in another aspect, a workflow can be initiated automatically by system 100 when aggregate weight 135 exceeds threshold weight 130. In one aspect, system 100 can initiate testing automatically. System 100, for example, can communicate with a testing system that can initiate testing of system 100 using assets in the state indicated by the applied tag, e.g., the state of assets in existence when aggregate weight 135 is determined to exceed threshold weight 130.

FIG. 2 is a block diagram illustrating an exemplary architecture for a data processing system 200. In one aspect, system 100 of FIG. 1 is implemented using one or more data processing systems having the architecture pictured in FIG. 2 or one similar thereto.

System 200 can include at least one processor 205, e.g., a central processing unit, coupled to memory elements 210 through a system bus 215 or other suitable circuitry. As such, system 200 can store program code within memory elements 210. Processor 205 executes the program code accessed from memory elements 210 via system bus 215 or the other suitable circuitry. In one aspect, system 200 is implemented as a computer or other programmable data processing apparatus that is suitable for storing and/or executing program code. It should be appreciated, however, that system 200 can be implemented in the form of any system including a processor and memory that is capable of performing and/or initiating the functions and/or operations described within this specification.

Memory elements 210 include one or more physical memory devices such as, for example, a local memory and one or more bulk storage devices. Local memory refers to RAM or other non-persistent memory device(s) generally used during actual execution of the program code. Bulk storage device(s) can be implemented as a hard disk drive (HDD), solid state drive (SSD), or other persistent data storage device. System 200 also can include one or more cache memories (not shown) that provide temporary storage of at least some program code in order to reduce the number of times program code must be retrieved from the bulk storage device during execution.

Input/output (I/O) devices such as a keyboard 230, a display 235, and a pointing device 240 optionally can be coupled to system 200. The I/O devices can be coupled to system 200 either directly or through intervening I/O controllers. One or more network adapters 245 also can be coupled to system 200 to enable system 200 to become coupled to other systems, computer systems, remote printers, and/or remote storage devices through intervening private or public networks. Modems, cable modems, wireless transceivers, and Ethernet cards are examples of different types of network adapters 245 that can be used with system 200.

As pictured in FIG. 2, memory elements 210 can store an application 250. It should be appreciated that memory elements 210 further can include an operating system (not shown) facilitating execution of application 250. Application 250, being implemented in the form of executable program code, is executed by system 200 and, as such, is considered an integrated part of system 200. When executed, application 250 provides instructions to system 200 that cause system 200 to initiate and/or perform the various operations described within this specification. Moreover, application 250, assets, weights, aggregate weights, threshold weight, and other parameters utilized by system 200 in performing the operations described within this specification are functional data structures that impart functionality when employed as part of system 200.

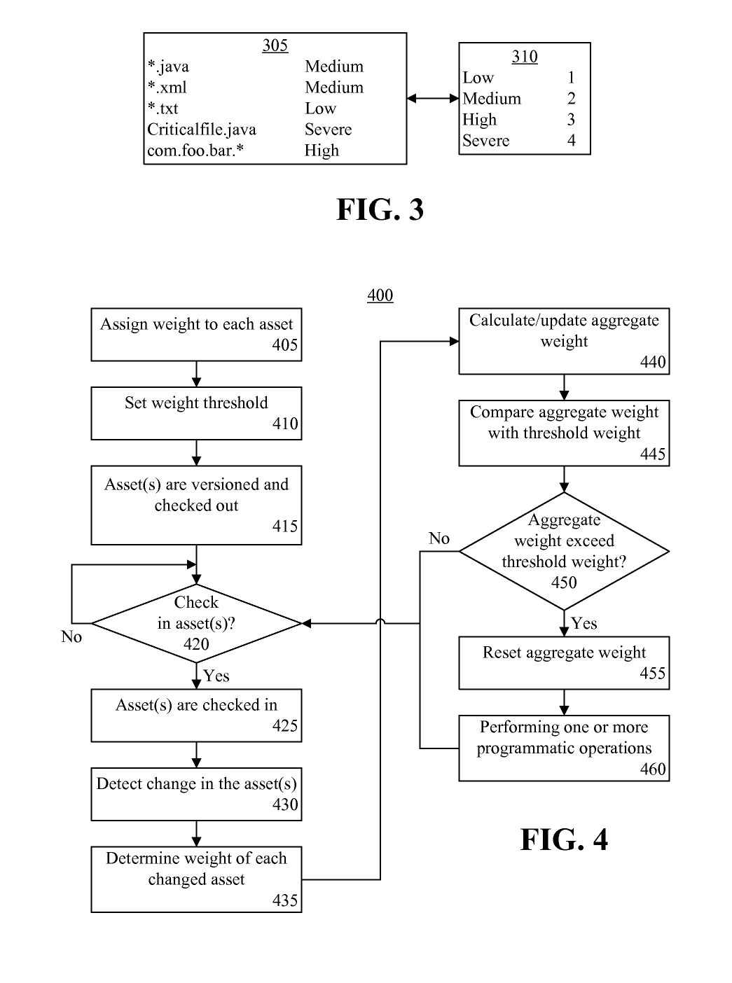

FIG. 3 is a block diagram illustrating an exemplary technique for weighting assets. As noted, each asset can be associated with a particular weight. FIG. 3 illustrates one technique for assigning, or associating, an asset with a weight. FIG. 3 illustrates a configuration file 305 and a mapping file 310 that can be used by, and stored within, the system of FIG. 1. Configuration file 305 and mapping file 310 are also examples of functional data structures that impart functionality when employed as part of a data processing system.

As pictured, configuration file 305 allows a developer or an administrator to correlate various attributes of assets, or particular assets, with different weight classes. The exemplary weight classes pictured in configuration file 305 include low, medium, high, and severe. In one example, configuration file 305 correlates different types of assets with different weight classes. In this example, asset type is determined according to file type or the extension of a file. Assets with an extension of “java” or “xml” are assigned the weight class of medium. Assets with an extension of “txt” are assigned the weight class of low.

In another example, specific assets can be assigned a weight class. In illustration, an enumerated or specific asset such as a particular file, a designated portion of a file such as a module or a function, a particular package having multiple files, or the like, can be listed within configuration file 305 and assigned a weight class. Referring to FIG. 3, the asset named “criticalfile.java,” for example, is assigned the weight class of severe. Any asset having “com.foo.bar” as part of its name regardless of extension is assigned a weight class of high. Any of a variety of attributes of a file, whether part of the name, part of metadata, or the like can be correlated with a weight class.

Mapping file 310 allows the system to select a particular weight for each asset based upon the weight class to which the asset is correlated. Thus, an asset that is determined to have a weight class of low has a weight of 1. An asset that is determined to have a weight class of medium has a weight of 2. An asset that is determined to have a weight class of high has a weight of 3. An asset that is determined to have a weight class of severe has a weight of 4.

An administrator or developer, as the case may be, can edit configuration file 305 to vary the manner in which assets are correlated with weight classes. For example, the developer can specify additional extensions, other specific assets, or the like. Each listed attribute can be assigned to a particular weight class. The administrator or developer further can edit mapping file 310 to change the actual weight, or value, that is used for a given weight class. By adjusting configuration file 305, mapping file 310, and/or the threshold weight, a developer or administrator can vary the amount of change that can be introduced into the system before tagging is performed and/or testing is initiated.

It should be appreciated that FIG. 3 illustrates one example of a weighting technique. Other weighting techniques also can be used. For example, the system can utilize a direct mapping of assets to weights. It should be appreciated that fewer or more weight classes can be used. Further, the particular weight assigned to a weight class as shown in FIG. 3 is not intended as a limitation. Weights can be assigned from low, medium, high, to severe as 1, 2, 4, and 8; or as 1, 2, 3, and 5, or the like without limitation.

FIG. 4 is a flow chart illustrating an exemplary method 400 of managing assets for a computer-based system. Method 400 can be performed by a system as described with reference to FIG. 1. Accordingly, method 400 can begin in a state where the system includes a plurality of assets managed, or under management, using version control technology.

In block 405, the system assigns a weight to each asset that is under management using version control. In one aspect, users such as developers can assign weights to assets. If a weight is not assigned to a particular asset, a default weight can be used for the asset. In block 410, a weight threshold is set. In one aspect, an administrator can set or specify the weight threshold that is to be used within the system.

In block 415, one or more assets can be versioned and checked out of the system. In block 420, the system determines whether one or more assets are to be checked back into the system. If one or more assets are to be checked back into the system, method 400 continues to block 425. If not, method 400 can continue looping until such time that an asset is to be checked back into the system. For ease of discussion, the process of monitoring for the checkout of an asset is not illustrated by FIG. 4.

A user, for example, can access the system through a client system and select an option to check in one or more currently checked out assets. Responsive to the user selecting such an option and/or specifying one or more assets to be checked in through an appropriate user interface, method 400 can continue to block 425. In block 425, the assets are checked into the system. For example, as part of the process of checking an asset into the system, the asset is committed to the data repository of the system.

In block 430, the system detects a change in one or more or all of the assets checked into the system in block 425. In one aspect, when checking an asset into the system, the user can select an option in the user interface indicating that the asset has changed since being checked out. In that case, the user, in effect, informs the system of the changed asset. In another aspect, the system can perform a comparison between the version of the asset that is checked in and an immediately prior version of the same asset. The comparison can be performed automatically or, for example, responsive to the user indicating that an asset has changed. In this manner, the system can determine whether an asset has changed or whether the asset is a file or a portion of a file, for example.

In block 435, the system determines the weight of each changed asset as determined in block 430. In some cases, a particular changed asset may be correlated with more than one weight. For example, an asset may be assigned a weight based upon file type, e.g., extension, but also have a particular name or portion of text in the asset name that is specifically listed in the configuration file. As a result, the asset may be mapped to two or more weights that may be different. In such cases, the system can select the greatest, or largest, weight when an asset is correlated with more than one different weight. For example, if the asset can be considered to belong to both the weight class of low and the weight class of medium, the system selects the weight corresponding to the weight class of medium.

In block 440, the system calculates and/or updates the aggregate weight maintained within the system. The aggregate weight is a function of the weight of each changed asset since the last time the system applied a tag or, if no tags have been applied, since the first changed assets were introduced. For example, the system adds the weight of each changed asset determined in block 435 to the current aggregate weight. As discussed, each asset used in calculating the aggregate weight can have differing weights and/or be checked in by one or more different users. In block 445, the system compares the current aggregate weight with the threshold weight that is established within the system.

In block 450, the system determines whether the aggregate weight exceeds the threshold weight. If so, method 400 proceeds to block 455. If not, method 400 continues to block 420 continue monitoring for further changed assets checked into the system.

Continuing with block 455, the system resets the aggregate weight. For example, since the system has determined that the aggregate weight has exceeded the threshold weight, various programmatic actions can be taken. In addition, the system resets the aggregate weight to a baseline value such as zero or the like to begin a new cycle of monitoring the amount of change introduced into the system as measured through the aggregated weights of changed assets. Accordingly, the system tracks the aggregate weight of a set of changes from a previous tag or, if no tag exists, from the first set of changes made to assets.

In block 460, the system performs one or more programmatic operations. The programmatic operations are performed responsive to the determination that the aggregate weight has exceeded the threshold weight. In one aspect, the system tags the state of assets in existence within the system at the time the aggregate weight is determined to exceed the threshold weight. As noted, tagging the state of assets means that the system creates a snapshot, or a record, of the version of each asset in existence at the time the aggregate weight exceeded the threshold weight. Because the system includes version control functionality, each version of each asset is preserved and can be recalled or restored based upon the particular snapshot a user desires to recall or restore.

In another aspect, the system can send a notification to one or more users that are responsible for the system. The notification can indicate, for example, that the system has changed a sufficient amount to merit testing. In still another aspect, the system can initiate self-testing or communicate with a testing system that is tasked with testing the system. The testing system, responsive to the communication, can initiate testing of the system, e.g., a standard testing workflow. Testing is performed using the state of the assets in existence when the tag is applied.

As discussed, in the event that testing results are not satisfactory, the system can revert to using a particular tag or snapshot of the assets despite further changed assets being introduced into the system while testing is taking place. As such, responsive to a decrease in accuracy and/or performance, prior versions of assets can be reinstated within the system in a relatively seamless manner.

The inventive arrangements disclosed herein provide for more automated tagging and/or snapshots of system assets for a learning system and the ability to roll back changes by incorporating version control functionality to manage the assets. Rather than testing the system at regular intervals, testing is initiated based upon the amount of change that is introduced into the system. Using amount of change as a guide as determined through aggregate weighting, unnecessary testing is avoided as is testing so infrequent that pinpointing the particular changes responsible for variations in performance is either too difficult or not possible. Employing version control functionality allows changes that result in reduced performance or accuracy to be abandoned by reverting to a prior snapshot of the assets used by the system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method, comprising:
detecting, using a processor, a change to at least one of a plurality of assets of a computer-based system, wherein the plurality of assets are managed using version control;
determining a weight for each changed asset;
calculating, using the processor, an aggregate weight according to the weight of each changed asset;
comparing, using the processor, the aggregate weight with a threshold weight; and
responsive to determining that the aggregate weight exceeds the threshold weight, recording a state of the plurality of assets of the computer-based system.

2. The method of claim 1, further comprising:
responsive to the aggregate weight exceeding the threshold weight, automatically initiating a workflow.

3. The method of claim 2, wherein the workflow is a test workflow for the computer-based system in which the recorded state of the plurality of assets is used for the test workflow.

4. The method of claim 1, wherein the plurality of assets comprise unstructured data.

5. The method of claim 1, wherein determining a weight for each changed asset comprises:
determining an attribute of each changed asset; and
correlating the attribute with a weight, wherein the correlated weight is used as the weight of the changed asset.

6. The method of claim 5, wherein at least one changed asset has a first attribute correlated with a first weight and a second attribute correlated with a second weight that is greater than the first weight, the method further comprising:
selecting the second weight as the weight for the changed asset.

7. The method of claim 1, wherein detecting, using a processor, a change to at least one of the plurality of assets comprises:
detecting a change to a first asset of a first type from the plurality of assets and a change to a second asset of a second type from the plurality of assets, wherein a weight of the first asset and a weight of the second asset varies according to type of each respective asset, and wherein the weight of the first asset and the weight of the second asset are combined to determine the aggregate weight.

8. The method of claim 1, wherein detecting, using a processor, a change to at least one of the plurality of assets comprises:
detecting a change to a first asset from the plurality of assets submitted by a first user and detecting a change to a second asset from the plurality of assets submitted by a second and different user, wherein the weight of the first asset and the weight of the second asset are combined to determine the aggregate weight.

9. A system comprising:
a processor programmed to initiate executable operations comprising:
detecting a change to at least one of a plurality of assets of a computer-based system, wherein the plurality of assets are managed using version control;
determining a weight for each changed asset;
calculating an aggregate weight according to the weight of each changed asset;
comparing the aggregate weight with a threshold weight; and
responsive to determining that the aggregate weight exceeds the threshold weight, recording a state of the plurality of assets of the computer-based system.

10. The system of claim 9, wherein the processor is further programmed to initiate an executable operation comprising:
responsive to the aggregate weight exceeding the threshold weight, automatically initiating a workflow.

11. The system of claim 10, wherein the workflow is a test workflow for the computer-based system in which the recorded state of the plurality of assets is used for the test workflow.

12. The system of claim 9 wherein the plurality of assets comprise unstructured data.

13. The system of claim 9, wherein determining a weight for each changed asset comprises:
determining an attribute of each changed asset; and
correlating the attribute with a weight, wherein the correlated weight is used as the weight of the changed asset.

14. The system of claim 13, wherein at least one changed asset has a first attribute correlated with a first weight and a second attribute correlated with a second weight that is greater than the first weight, wherein the processor is further programmed to initiate an executable operation comprising:
selecting the second weight as the weight for the changed asset.

15. The system of claim 9, wherein detecting a change to at least one of the plurality of assets comprises:
detecting a change to a first asset of a first type from the plurality of assets and a change to a second asset of a second type from the plurality of assets, wherein a weight of the first asset and a weight of the second asset varies according to type of each respective asset, and wherein the weight of the first asset and the weight of the second asset are combined to determine the aggregate weight.

16. The system of claim 9, wherein detecting a change to at least one of the plurality of assets comprises:
detecting a change to a first asset from the plurality of assets submitted by a first user and detecting a change to a second asset from the plurality of assets submitted by a second and different user, wherein the weight of the first asset and the weight of the second asset are combined to determine the aggregate weight.

17. A computer program product, the computer program product comprising a computer readable storage medium having program code stored thereon, the program code executable by a processor to perform a method comprising:
detecting, using the processor, a change to at least one of a plurality of assets of a computer-based system, wherein the plurality of assets are managed using version control;
determining, using the processor, a weight for each changed asset;
calculating, using the processor, an aggregate weight according to the weight of each changed asset;
comparing, using the processor, the aggregate weight with a threshold weight; and
responsive to determining that the aggregate weight exceeds the threshold weight, recording a state of the plurality of assets of the computer-based system using the processor.

18. The computer program product of claim 17, wherein determining a weight for each changed asset comprises:
determining an attribute of each changed asset; and
correlating the attribute with a weight, wherein the correlated weight is used as the weight of the changed asset.

19. The computer program product of claim 17, wherein detecting, using the processor, a change to at least one of the plurality of assets comprises:
detecting a change to a first asset of a first type from the plurality of assets and a change to a second asset of a second type from the plurality of assets, wherein a weight of the first asset and a weight of the second asset varies according to type of each respective asset, and wherein the weight of the first asset and the weight of the second asset are combined to determine the aggregate weight.

20. The computer program product of claim 17, wherein detecting, using the processor, a change to at least one of the plurality of assets comprises:
detecting a change to a first asset from the plurality of assets submitted by a first user and detecting a change to a second asset from the plurality of assets submitted by a second and different user, wherein the weight of the first asset and the weight of the second asset are combined to determine the aggregate weight.
